(19) United States
(12) Patent Application Publication
(10) Pub. No.: US 2014/0204753 A1
(43) Pub. Date: Jul. 24, 2014

(54) WIRELESS COMMUNICATION DEVICE

(71) Applicant: KABUSHIKI KAISHA TOSHIBA, Tokyo (JP)

(72) Inventors: Koji AKITA, Yokohama-Shi (JP); Tsuyoshi KOGAWA, Kawasaki-Shi (JP); Takayoshi ITO, Yokohama-Shi (JP); Seiichiro HORIKAWA, Yokohama-Shi (JP)

(73) Assignee: KABUSHIKI KAISHA TOSHIBA, Tokyo (JP)

(21) Appl. No.: 14/144,228

(22) Filed: Dec. 30, 2013

(30) Foreign Application Priority Data
Jan. 21, 2013 (JP) 2013-008490

(51) Int. Cl. H04W 28/02; H04W 72/12

(52) U.S. Cl. CPC H04W 28/0289; H04W 72/1252
USPC 370/235

(57) ABSTRACT

A wireless communication device has a first wireless communication unit capable of performing wireless communication within a first communication distance, a second wireless communication unit capable of performing wireless communication within a second communication distance greater than the first communication distance, and a controller configured to assign at least a part of the wireless communication performed by the second wireless communication unit to the first wireless communication unit instead of the second wireless communication unit, based on a communication history of the second wireless communication unit stored after the wireless communication using the first wireless communication unit becomes available.

### CROSS REFERENCE TO RELATED APPLICATIONS

This application is based upon and claims the benefit of priority from the prior Japanese Patent Application No. 2013-8490, filed on Jan. 21, 2013 the entire contents of which are incorporated herein by reference.

### FIELD

Embodiments of the present invention relate to a wireless communication device for realizing wireless communication using a plurality of wireless methods.

### BACKGROUND

There is suggested a technique for reducing the traffic load on cellular wireless communication such as W-CDMA by assigning a part of traffic in the cellular wireless communication to wireless LAN.

However, this does not necessarily lead to the reduction in traffic load, which is because the range available for wireless LAN communication is narrower than the range available for cellular wireless communication. That is, when a terminal gets out of the communication range for wireless LAN, the terminal cannot conduct communication by the wireless LAN, and therefore, it is impossible to reduce traffic load in cellular wireless communication.

### BRIEF DESCRIPTION OF THE DRAWINGS

FIG. 1 is a block diagram showing a schematic structure of a wireless communication device 1 according to a first embodiment.

FIG. 2 is a diagram showing an example of communication configuration for the wireless communication device 1 of FIG. 1.

FIG. 3 is a diagram showing an example of movement routes of the wireless communication device 1.

FIG. 4 is a diagram showing an example of a communication history.

FIG. 5 is a diagram showing another example of the communication history.

FIG. 6 is a diagram showing a still another example of the communication history.

FIG. 7 is a diagram showing a further example of the communication history.

FIG. 8 is a diagram showing an example of movement routes of the wireless communication device 1.

FIG. 9 is a diagram showing a still further example of the communication history.

FIG. 10 is a block diagram showing a modification example derived from FIG. 1.

FIG. 11 is a block diagram showing a modification example derived from FIG. 1.

FIG. 12 is a sequence diagram showing a first example of communication procedure for the wireless communication device 1.

FIG. 13 is a sequence diagram showing a second example of communication procedure for the wireless communication device 1.

FIG. 14 is a sequence diagram showing a third example of communication procedure for the wireless communication device 1.

FIG. 15 is a sequence diagram showing a fourth example of communication procedure for the wireless communication device 1.

FIG. 16 is a sequence diagram showing a fifth example of communication procedure for the wireless communication device 1.

FIG. 17 is a sequence diagram showing a sixth example of communication procedure for the wireless communication device 1.

FIG. 18 is a block diagram showing a schematic structure of a wireless communication system 10 having the wireless communication device 1 according to a second embodiment.

FIG. 19 is a block diagram showing a schematic structure of the wireless communication device 1 (corresponding to a user terminal 11) according to the second embodiment.

FIG. 20 is a block diagram showing a schematic structure of the wireless communication device 1 (user terminal 11) according to a third embodiment.

FIG. 21 is a block diagram showing a schematic structure of the wireless communication device 1 (user terminal 11) according to a fourth embodiment.

FIG. 22 is a block diagram showing a schematic structure of the wireless communication system 10 having the wireless communication device 1 of FIG. 21.

FIG. 23 is a block diagram showing a schematic structure of the wireless communication device 1 (user terminal 11) according to a fifth embodiment.

FIG. 24 is a block diagram showing a schematic structure of the wireless communication system 10 according to a seventh embodiment.

### DETAILED DESCRIPTION

According to one embodiment, a wireless communication device has a first wireless communication unit capable of performing wireless communication within a first communication distance, a second wireless communication unit capable of performing wireless communication within a second communication distance greater than the first communication distance, and a controller configured to assign at least a part of the wireless communication performed by the second wireless communication unit to the first wireless communication unit instead of the second wireless communication unit, based on a communication history of the second wireless communication unit stored after the wireless communication using the first wireless communication unit becomes available.

Embodiments will now be explained with reference to the accompanying drawings.

### First Embodiment

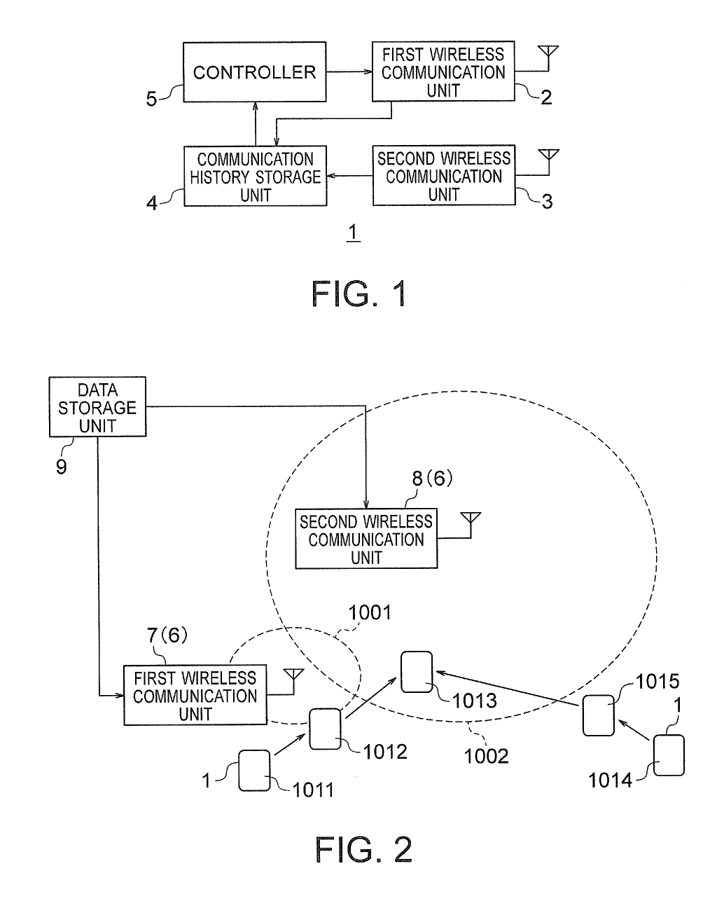

FIG. 1 is a block diagram showing a schematic structure of a wireless communication device 1 according to a first embodiment. The wireless communication device 1 of FIG. 1 is a user terminal such as a cellular phone and a smartphone. The wireless communication device 1 of FIG. 1 has a first wireless communication unit 2, a second wireless communication unit 3, a communication history storage unit 4, and a controller 5.

The first wireless communication unit 2 can wirelessly communicate with a first wireless communication unit of a communication partner located within a first communication distance.

The second wireless communication unit 3 can wirelessly communicate with a second wireless communication unit of a communication partner located within a second communication distance greater than the first communication distance.

The communication history storage unit 4 stores a communication history of the second wireless communication unit 3 after the wireless communication using the first wireless communication unit 2 becomes available. Accordingly, when the wireless communication using the first wireless communication unit 2 becomes available, information indicating the fact is transmitted from the first wireless communication unit 2 to the communication history storage unit 4. Upon receiving this information, the communication history storage unit 4 stores the communication history of the wireless communication performed by the second wireless communication unit 3 since then.

Note that the communication history storage unit 4 may not be necessarily provided in the wireless communication device 1 of FIG. 1, and may be provided outside the wireless communication device 1. In this case, the wireless communication device 1 has a storage controller for storing the communication history in the external communication history storage unit 4. The controller 5 may function also as the storage controller.

The controller 5 assigns at least a part of the wireless communication performed by the second wireless communication unit 3 in the past to the first wireless communication unit 2, using the communication history stored in the communication history storage unit 4.

FIG. 2 is a diagram showing an example of communication configuration for the wireless communication device 1 of FIG. 1. A communication partner 6 of the wireless communication device 1 of FIG. 1 has a first wireless communication unit 7 and a second wireless communication unit 8, which may not be necessarily incorporated into one wireless machine and may be provided at different locations. In this specification, the first wireless communication unit 7 and second wireless communication unit 8 are collectively called as communication partner 6 for convenience.

The first wireless communication unit 7 may be, e.g., an access point of a wireless LAN or a KIOSK terminal supporting proximity communication. The first wireless communication unit 7 wirelessly communicates with the wireless communication device 1 located within the first communication distance. The second wireless communication unit 8 may be, e.g., a base station of cellular communication. The second wireless communication unit 8 wirelessly communicates with the wireless communication device 1 located within the second communication distance. The first wireless communication unit 7 and the second wireless communication unit 8 can acquire the same data from a data storage unit 9.

The data storage unit 9 may be a server on the Internet capable of supplying data to the first wireless communication unit 7 and second wireless communication unit 8. When the data storage unit 9 is a server on the Internet, each of the first wireless communication unit 7 and second wireless communication unit 8 acquires data from the data storage unit 9 through the Internet connection.

In FIG. 2, the first wireless communication unit 7 can perform wireless communication within a range of the first communication distance (hereinafter referred to as first communication range) 1001, while the second wireless communication unit 8 can perform wireless communication within a range of the second communication distance (hereinafter referred to as second communication range) 1002.

For example, in FIG. 2, suppose a case where a user of the wireless communication device 1 of FIG. 1 moves along a route from Point 1011->1012->1013, to perform wireless communication at Point 1013 utilizing the second wireless communication unit 3. Point 1011 is out of both the first communication range 1001 and the second communication range 1002. Point 1012 is within the first communication range 1001 but out of the second communication range 1002. Point 1013 is within the second communication range 1002 but out of the first communication range 1001.

The communication history storage unit 4 stores the communication history of the second wireless communication unit 3 after the user passes through Point 1012. If the user starts wireless communication utilizing the second wireless communication unit 3 when he/she arrives at Point 1013, access destination information and access time information at this time is stored in the communication history storage unit 4 as the communication history.

On the other hand, when the user moves along a route from Point 1014->1015->1013 as shown in FIG. 2, this movement route does not include the first communication range 1001. Thus, even when the user performs wireless communication at Point 1013 utilizing the second wireless communication unit 3, the information is not stored in the communication history storage unit 4.

That is, even when the user performs wireless communication at the same point, whether or not to store the communication history is determined depending on whether the user previously passed through the first communication range 1001. Since the communication history is stored to assign a part of wireless communication performed by the second wireless communication unit 3 to the first wireless communication unit 2, there is no need to store the communication history when the user takes a route on which wireless communication using the first wireless communication unit 2 is unavailable.

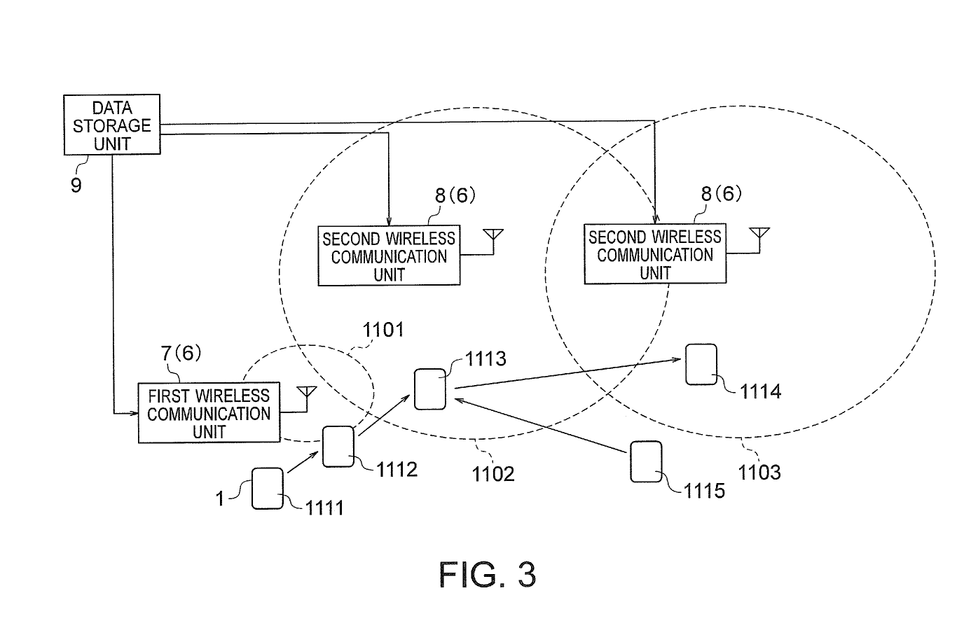

In the example shown in FIG. 2, the communication partner 6 has one first wireless communication unit 7 and one second wireless communication unit 8. However, the communication partner 6 may have a plurality of second wireless communication units 8 as shown in FIG. 3. In FIG. 3, when the user moves along a route from Point 1111->1112->1113->1114, if he/she wirelessly communicates with the second wireless communication unit 8 at least one of Point 1113 and Point 1114 after passing through Point 1112 within a first communication range 1101, the communication history of the wireless communication performed with the second wireless communication unit 8 is stored in the communication history storage unit 4.

On the other hand, when the user moves along a route from Point 1115->1113->1114, if he/she wirelessly communicates with the second wireless communication unit 8 at Point 1113 and further with another second wireless communication unit 8 at Point 1114 without passing through Point 1112, no communication history is stored in the communication history storage unit 4.

As stated above, the communication history of the second wireless communication unit 3 after passing through the communication range of the first wireless communication unit 2 is stored in the communication history storage unit 4, to grasp when and where the wireless communication assignable to the first wireless communication unit 2 was performed. By performing wireless communication using the first wireless communication unit 2 based on this communication history, traffic load on the second wireless communication unit 3 can be reduced.

For example, when the behavior of the user of the wireless communication device 1 has a specific pattern in commuting to work, commuting to school, shopping, etc., storing the pattern as a communication history makes it possible to assign at least a part of wireless communication performed by the user utilizing the second wireless communication unit 3 to the first wireless communication unit 2, which can reduce the frequency of wireless communication using the second wireless communication unit 3.

### (Timing for Storing Communication History)

As stated above, the communication history storage unit 4 stores the communication history of the second wireless communication unit 3 after the wireless communication using the first wireless communication unit 2 becomes available. The storage of the communication history may be stopped after a predetermined time has elapsed since the storage operation was started. That is, the communication history storage unit 4 may store the communication history of the second wireless communication unit 3 only for a predetermined time after the wireless communication using the first wireless communication unit 2 becomes available.

For example, in FIG. 3, suppose a case where the user moves along a route from Point 1111->1112->1113->1114, and a predetermined time has elapsed while the user is moving from Point 1113 to Point 1114. In this case, information about the wireless communication with the second wireless communication unit 8 at Point 1113 is stored in the communication history storage unit 4, but information about the wireless communication with the second wireless communication unit 8 at Point 1114 is not stored. Since Point 1113 is closer to the first communication distance than Point 1114, it is assumed that communication traffic generated at Point 1113 can be shared with the first wireless communication unit 2 more certainly. Thus, in some cases, it is desirable to store only the communication history at Point 1113, omitting the communication history at Point 1114. Generally, movement distance is assumed to become shorter as elapsed time becomes shorter. By limiting the predetermined time, the communication history of the second wireless communication unit 3 can be stored only within a predetermined range from the first communication distance in which the wireless communication using the first wireless communication unit 2 is available.

Instead, the communication history storage unit 4 may stop storing the communication history of the second wireless communication unit 3 when an instruction to stop history acquisition is given after the storage operation is started.

The instruction to stop history acquisition may be, e.g., a command generated by the input from the user of the wireless communication device 1. In this case, storage of the communication history can be controlled based on the request from the user.

Further, the instruction to stop history acquisition may be, e.g., a command transmitted from the communication partner through the first wireless communication unit 2. For example, if a command for instructing the stop of history acquisition is transmitted using the first wireless communication unit 2 when the user leaves a facility such as station, airport, movie theater, amusement park, sport venue, etc., communication history can be stored only while the user stays within the facility.

The instruction to stop history acquisition may be, e.g., a command transmitted from the communication partner through the second wireless communication unit 3. For example, when a plurality of second wireless communication units 3 are provided, a second wireless communication unit 3 which has leeway in communication traffic has no need to share any communication traffic with the first wireless communication unit 2. Thus, the instruction to stop history acquisition may be transmitted from this second wireless communication unit 3 not to store the communication history about the communication traffic which is less required to be shared with the first wireless communication unit 2.

### (Details of Communication History)

The communication history may be, e.g., the address itself representing requested data, or a part of the address. For example, the URL (Uniform Resource Locator) address is expressed as http://AAA/BBB/CCC/DDD/EEE, its upper part, such as http://AAA/BBB/CCC/DDD and http://AAA/BBB/CCC, may be used instead.

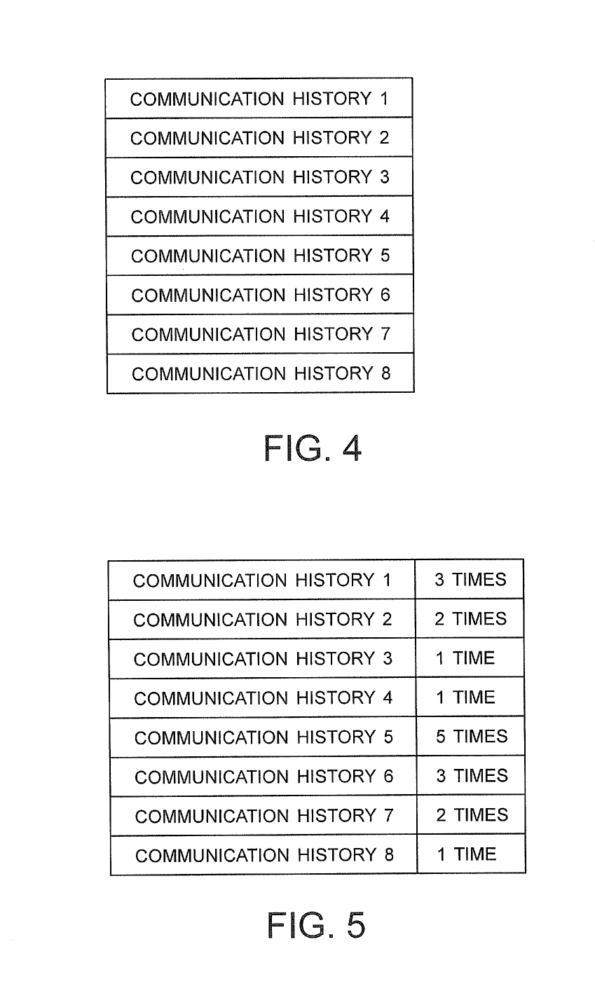

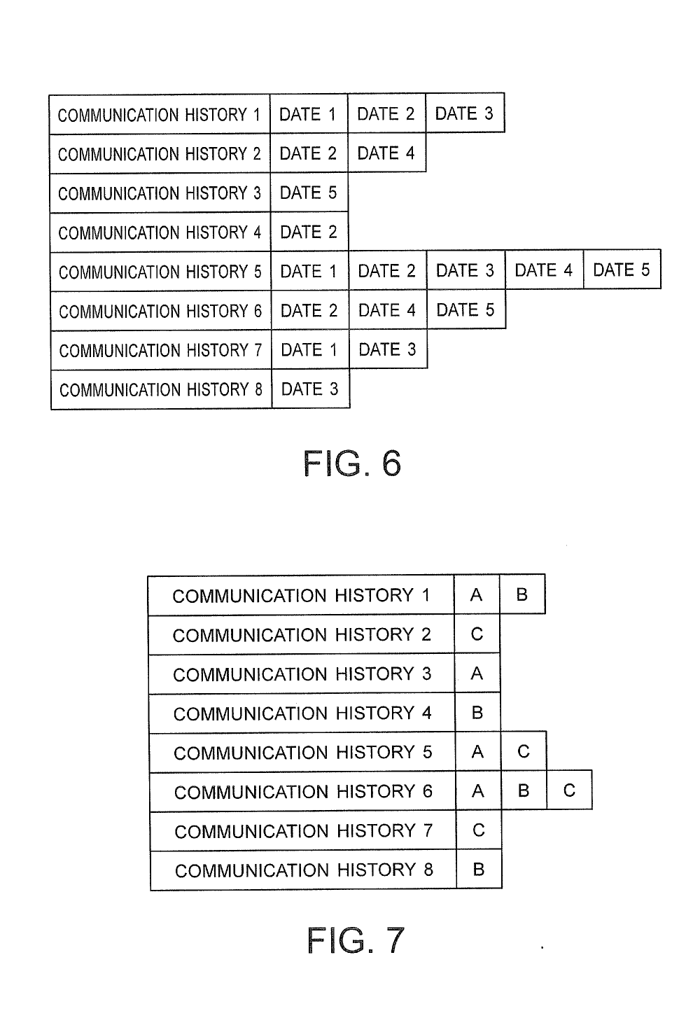

As shown in FIG. 4, the communication history may be given in a list form expressing a plurality of communication histories arranged in chronological order. Instead, as shown in FIG. 5, the communication history may be given in a list form expressing the frequency of access with respect to each access destination accessed by the second wireless communication unit 3. In FIG. 5, each of communication histories 1 to 8 shows different access destination information. Instead, as shown in FIG. 6, the communication history may be given in a list form expressing time information such as an access date with respect to each access destination accessed by the second wireless communication unit. In the example shown in FIG. 6, dates are recorded, and information about minutes and seconds may be additionally recorded.

By storing the information about the number of times of communication and access time as shown in FIG. 5 and FIG. 6, access destinations accessed with higher frequency are made clear, which makes it easy to select an access destination suitable for the wireless communication using the first wireless communication unit 2. Accordingly, communication traffic of the second wireless communication unit 3 can be reduced more effectively.

Instead, as shown in FIG. 7, the communication history may be given in a list form expressing identification information about the first wireless communication units which became available for communication among all of the first wireless communication units 7 of the communication partner, with respect to each access destination accessed by the second wireless communication unit 3. In the example of FIG. 7, the access destination of communication history 1 shows that wireless communication using the second wireless communication unit 3 is performed after passing through the communication range of a first wireless communication unit A of the communication partner, and after passing through the communication range of a first wireless communication unit B of the communication partner.

Further, in the example of FIG. 7, the access destination of communication history 6 shows that wireless communication using the second wireless communication unit 3 is performed after passing through the communication ranges of three first wireless communication units A, B, and C of the communication partner. This is the access destination accessed with the highest frequency.

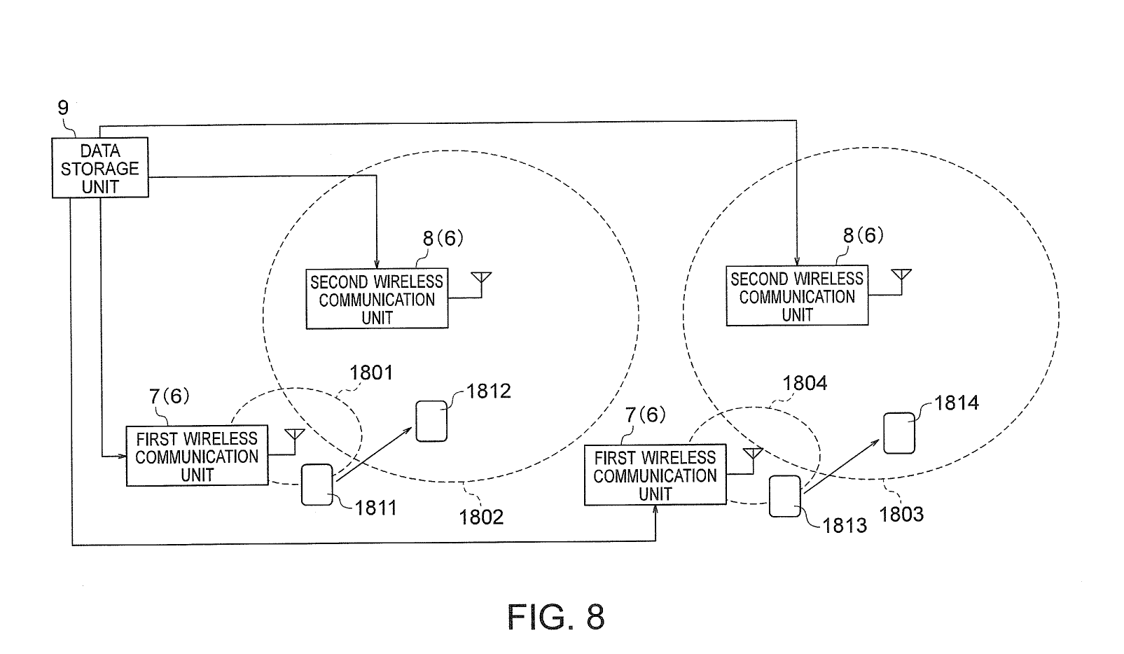

FIG. 8 is shows an example where the communication partner of the wireless communication device 1 has two first wireless communication units A and B. Here, when the wireless communication device 1 moves from Point 1811 to Point 1812 and wirelessly communicates with the second wireless communication unit 8 at Point 1812, communication traffic of this communication history is assumed to be easily shared with the first wireless communication unit A of the communication partner. Further, when the wireless communication device 1 moves from Point 1813 to Point 1814 and wirelessly communicates with the second wireless communication unit 8 at Point 1814, communication traffic of this communication history is assumed to be easily shared with the first wireless communication unit B of the communication partner.

Thus, as shown in FIG. 7, by storing the communication history related to the first wireless communication units A and B of the communication partner which are available for communication, communication traffic can be shared with a specific first wireless communication unit more effectively.

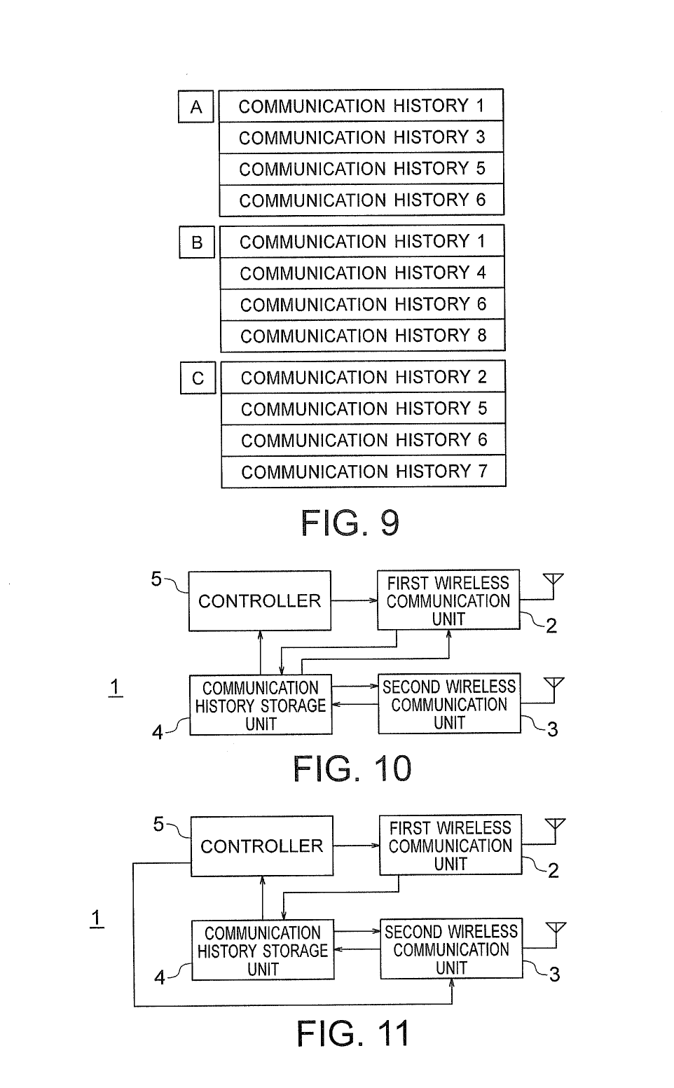

Note that identification information such A, B, and C shown in the example of FIG. 7 may be used to identify each first wireless communication unit of the communication partner or to collectively identify a plurality of first wireless communication units existing nearby. For example, a plurality of first wireless communication units installed in a certain facility may be managed with one identifier. As shown in FIG. 9, the communication history may be stored in the communication history storage unit 4 in a list form expressing access destinations with respect to each first wireless communication unit.

Further, in the communication histories stored in the communication history storage unit 4, old communication histories stored a predetermined time before may be automatically eliminated. This makes it possible to reduce communication traffic effectively, based on the newer information.

### (Flow of Signals in the Wireless Communication Device 1)

In the example shown in FIG. 1, the second wireless communication unit 3 stores a communication history in the communication history storage unit 4, and the stored communication history is transferred to the first wireless communication unit 2 through the controller 5. On the other hand, as shown in FIG. 10, at least a part of communication histories stored in the communication history storage unit 4 may be directly transmitted to the first wireless communication unit 2 without passing through the controller 5.

Instead, as shown in FIG. 11, the controller 5 may further control the communication related to the second wireless communication unit 3.

### (Communication Procedure for the Wireless Communication Device 1)

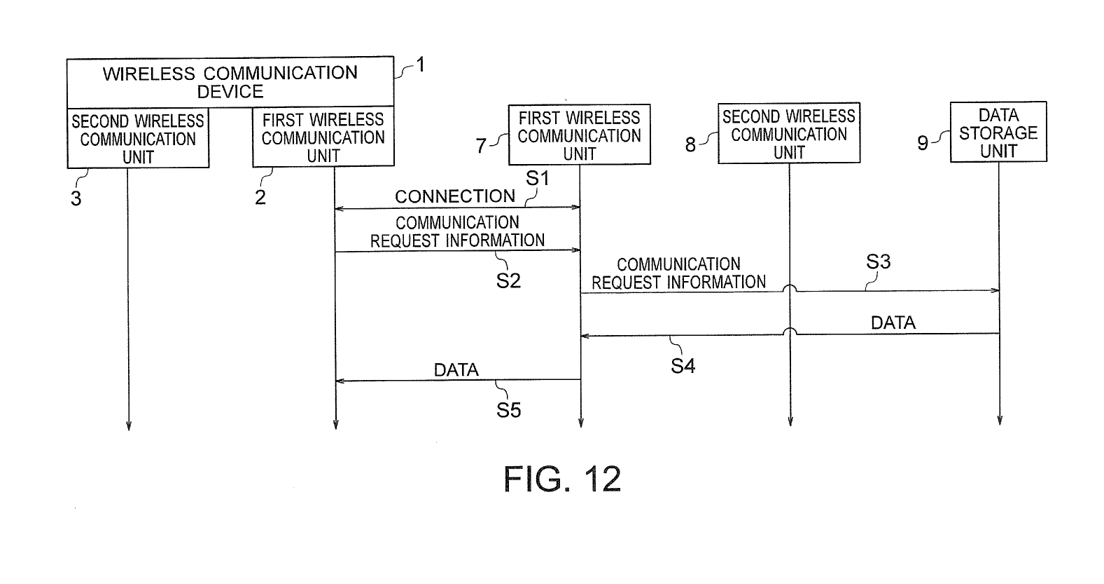

FIG. 12 is a sequence diagram showing a first example of communication procedure for the wireless communication device 1. When the first wireless communication unit 2 of the wireless communication device 1 becomes available for communication and connected to the first wireless communication unit 7 of the communication partner (Step S1), the wireless communication device 1 generates communication request information based on the communication history stored in the communication history storage unit 4, and transmits this information to the first wireless communication unit 7 of the communication partner (Step S2).

Upon receiving this information, the first wireless communication unit 7 of the communication partner acquires a part of or the whole of the requested data from the data storage unit 9 (Steps S3 and S4), and transmits it to the wireless communication device 1 through the first wireless communication unit 7 (Step S5).

In this way, the first wireless communication unit 2 can acquire a part of communication traffic generated in the second wireless communication unit 3.

The communication request information generated at Step S2 may be a communication history itself, for example. In this case, the first wireless communication unit 7 receiving the communication request information operates to acquire a part of or the whole of the data.

Instead, the communication request information may be, e.g., obtained by extracting a part of the communication history. In this case, when the communication history includes information about the number of times of communication as shown in FIG. 5, the communication history with a higher frequency may be preferentially extracted.

Instead, when the communication request information includes access time information as shown in FIG. 6, the latest communication history may be preferentially extracted.

Instead, when the communication request information includes information for identifying the first wireless communication unit 7 as shown in FIG. 7 and FIG. 9, only the communication history corresponding to the first wireless communication unit 7 available for communication may be extracted.

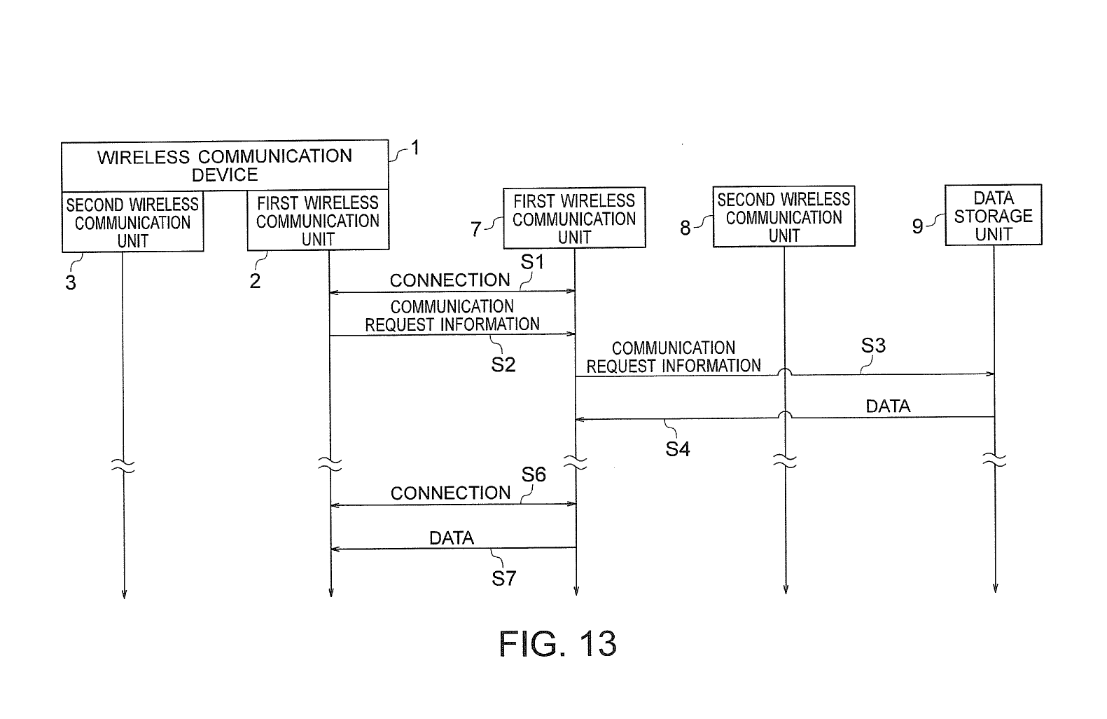

FIG. 13 is a sequence diagram showing a second example of communication procedure for the wireless communication device 1. The second example shown in FIG. 13 is the same as FIG. 12 in Steps S1 to S4.

At Step S4, the first wireless communication unit 7 of the communication partner receives data from the data storage unit 9 and waits until it can communicate with the first wireless communication unit 2 of the wireless communication device 1. When the first wireless communication units 2 and 7 are connected and communicate with each other (Step S6), the first wireless communication unit 7 transmits the previously requested data to the wireless communication device 1 (Step S7).

In the process of FIG. 13, the first wireless communication unit 7 of the communication partner can previously acquire data from the data storage unit 9, which prevents a defect that the timing of transmitting the data to the wireless communication device 1 is delayed when much time is required to acquire the data.

When the user of the wireless communication device 1 has a specific behavior pattern regularly repeated, such as when the user routinely passes through a certain station to commute to work, transmitting communication request information based on the communication history stored until a certain day makes it possible to acquire the data based on the history at high speed on the next day.

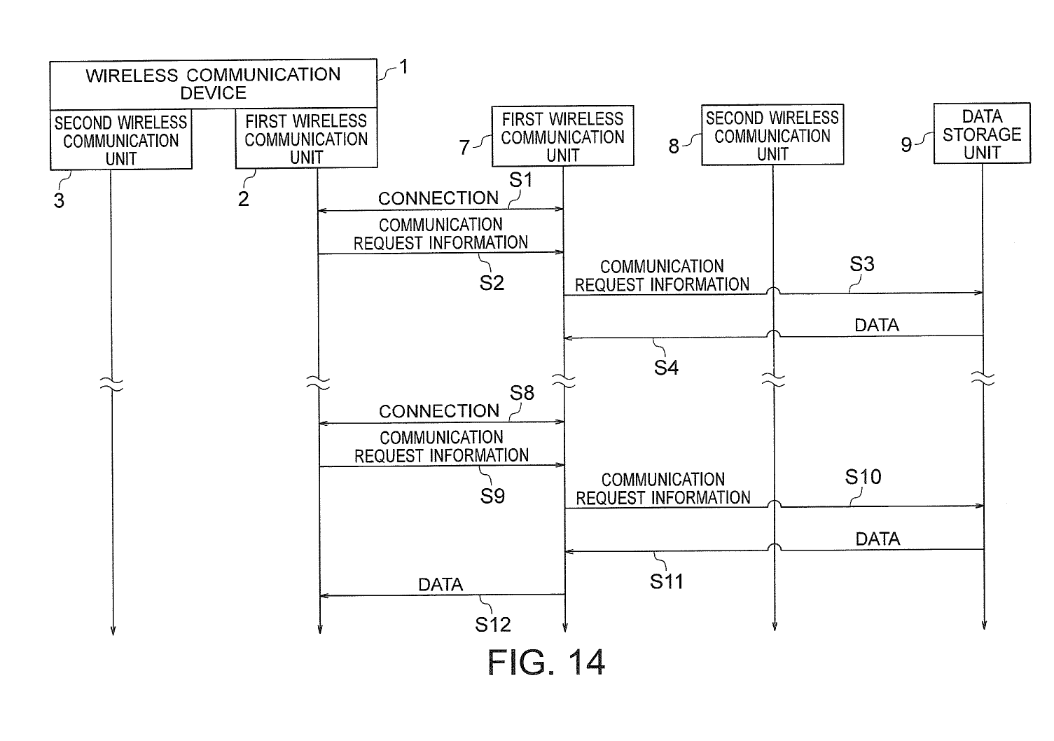

FIG. 14 is a sequence diagram showing a third example of communication procedure for the wireless communication device 1. In the third example shown in FIG. 14, when the first wireless communication unit 7 of the communication partner immediately after receiving data from the data storage unit 9 cannot wirelessly communicate with the first wireless communication unit 2 of the wireless communication device 1, the first wireless communication unit 7 waits until it is connected to the first wireless communication unit 2 of the wireless communication device 1 again. When the communication connection is established (Step S8), the first wireless communication unit 7 acquires data from the data storage unit 9 in accordance with the communication request information newly transmitted from the first wireless communication unit 2 of the wireless communication device 1. If the first wireless communication unit 2 of the wireless communication device 1 is available for wireless communication at that point, the acquired data is transmitted to the wireless communication device 1 through the first wireless communication unit 7 (Steps S9 to S12).

In the process of FIG. 14, the data corresponding to newer communication request information can be constantly transmitted to the wireless communication device 1. In this case, the first wireless communication unit 7 of the communication partner may acquire, from the data storage unit 9, only a difference from the data acquired based on the previous communication request information (Step S11). This makes it possible to shorten the time for acquiring data from the data storage unit 9. Further, when transmitting new communication request information (Step S9), the wireless communication device 1 may transmit only a difference from the communication request information previously transmitted.

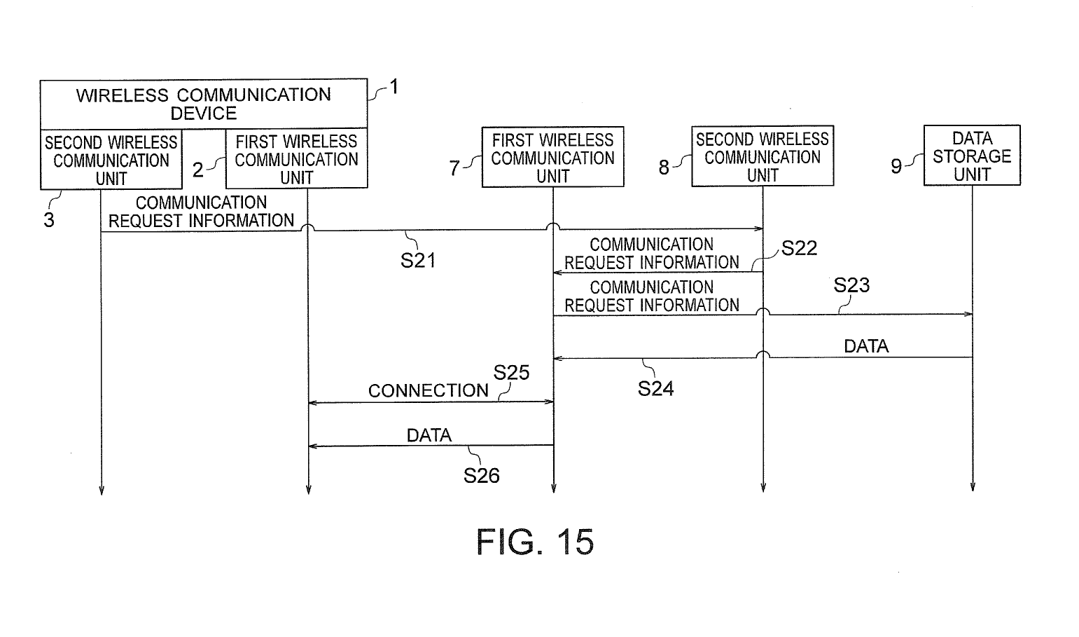

FIG. 15 is a sequence diagram showing a fourth example of communication procedure for the wireless communication device 1. The fourth example is different from the first to third examples in that the communication request information is transmitted from the second wireless communication unit 3 in the wireless communication device 1.

The wireless communication device 1 transmits communication request information to the second wireless communication unit 8 of the communication partner by using the second wireless communication unit 3 (Step S21). The second wireless communication unit 8 of the communication partner receives the communication request information and transmits it to the first wireless communication unit 7 (Step S22).

The first wireless communication unit 7 acquires data from the data storage unit 9, based on the communication request information (Steps S23 and S24). When the first wireless communication unit 7 is connected to and can communicate with the first wireless communication unit 2 of the wireless communication device 1 (Step S25), the first wireless communication unit 7 transmits the acquired data to the wireless communication device 1 (Step S26).

Since the first wireless communication unit 7 of the communication partner can previously acquire the data from the data storage unit 9, the first wireless communication unit 7 can quickly transmit the data to the wireless communication device 1 when the first wireless communication unit 2 of the wireless communication device 1 becomes available for communication.

The second wireless communication unit 8 of the communication partner may transmit the communication request information to, e.g., one or more first wireless communication units 7 which geographically close. In this way, the wireless communication device 1 can acquire data from the first wireless communication unit 7 of the communication partner existing close to the point from which the communication request information was transmitted.

As shown in FIG. 7 and FIG. 9, when the communication history includes information for identifying the first wireless communication unit 7 of the communication partner, communication request information may be transmitted using the second wireless communication unit 3 when approaching the corresponding first wireless communication unit 7, to receive data from the corresponding first wireless communication unit 7. In this case, a location information acquisition unit such as GPS may be further provided to detect that the wireless communication device 1 is approaching the corresponding first wireless communication unit 7.

Further, when approaching the corresponding first wireless communication unit 7, the user of the wireless communication device 1 may be notified of the fact that he/she is approaching the corresponding first wireless communication unit 7 and of information about the location, via sound and display. In this case, the communication request information may be transmitted only when an input is given by the user.

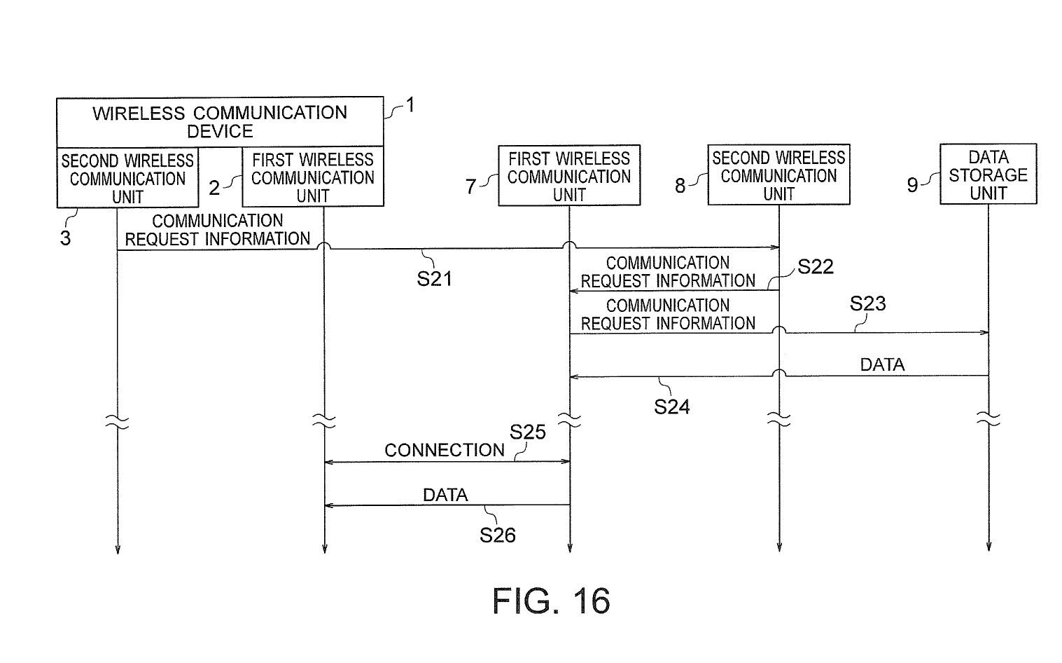

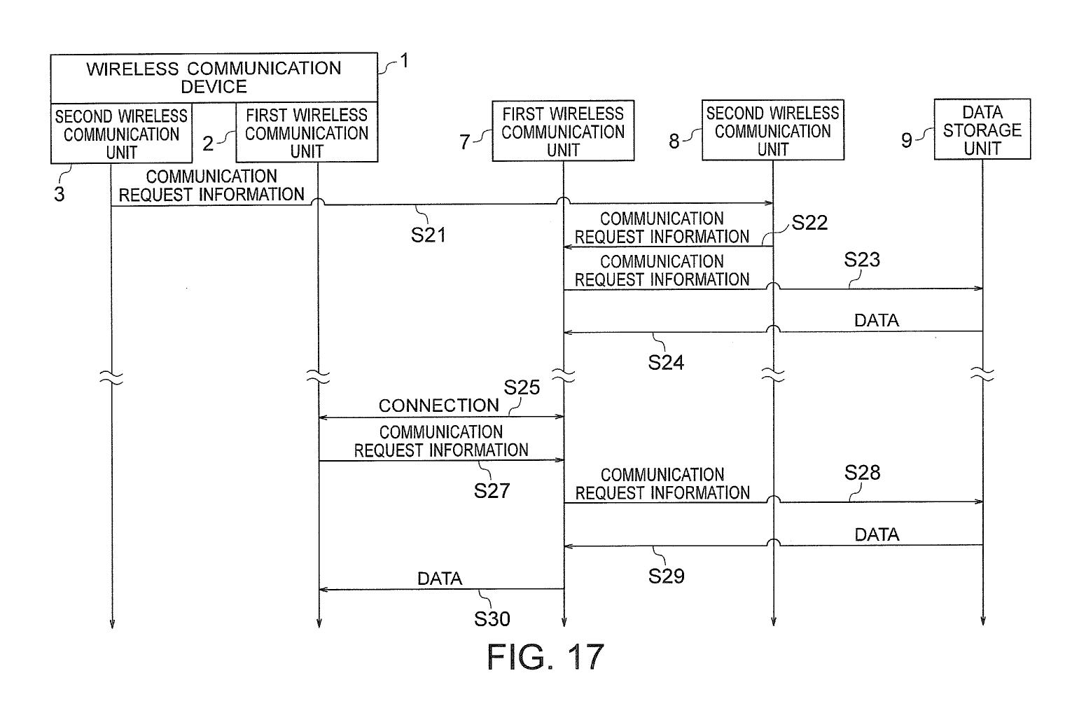

FIG. 16 is a sequence diagram showing a fifth example of communication procedure for the wireless communication device 1, and FIG. 17 is a sequence diagram showing a sixth example of communication procedure for the wireless communication device 1.

When the communication history includes information for identifying the first wireless communication unit 7, communication request information may be transmitted using the second wireless communication unit 3, regardless of the timing when the first wireless communication unit 7 actually acquires data.

When the user of the wireless communication device 1 has a specific behavior pattern regularly repeated, such as when the user routinely passes through a certain station to commute to work, data can be effectively acquired from the first wireless communication unit 7 of the communication partner by routinely updating the communication request information regardless of the timing when the first wireless communication unit 7 is actually connected.

In this case, as shown in FIG. 17, the communication request information may be transmitted also when the first wireless communication unit 2 is connected to the first wireless communication unit 7 (Steps S25 and S27).

Since communication request information based on the newer communication history can be further transmitted, communication traffic can be effectively shared with the first wireless communication unit 2.

As stated above, in the first embodiment, communication history of the second wireless communication unit 3 is stored after the wireless communication using the first wireless communication unit 2 becomes available, and thus at least a part of wireless communication performed by the second wireless communication unit 3 in the past can be assigned to the first wireless communication unit instead of the second wireless communication unit 3. Accordingly, communication traffic of the second wireless communication unit 3 can be effectively shared with the first wireless communication unit 2.

By accessing, through the first wireless communication unit 2, the access destination routinely accessed by the user, necessary information can be acquired without alerting the user's attention, which improves the convenience of the user.

Note that when the first wireless communication unit 2 performs wireless communication on behalf of the second wireless communication unit 3, its communication partner may be different from the communication partner of the first wireless communication unit 2 stored in the communication history. For example, after performing wireless communication at station A using the second wireless communication unit 3, similar wireless communication may be performed at station B using the first wireless communication unit 2. Further, after performing wireless communication with server A using the second wireless communication unit 3, similar wireless communication may be performed with server B, which can provide similar communication service to server A, using the first wireless communication unit 2.

### Second Embodiment

A second embodiment to be explained below is characterized in that the user terminal can directly access a first server device without accessing a cellular base station.

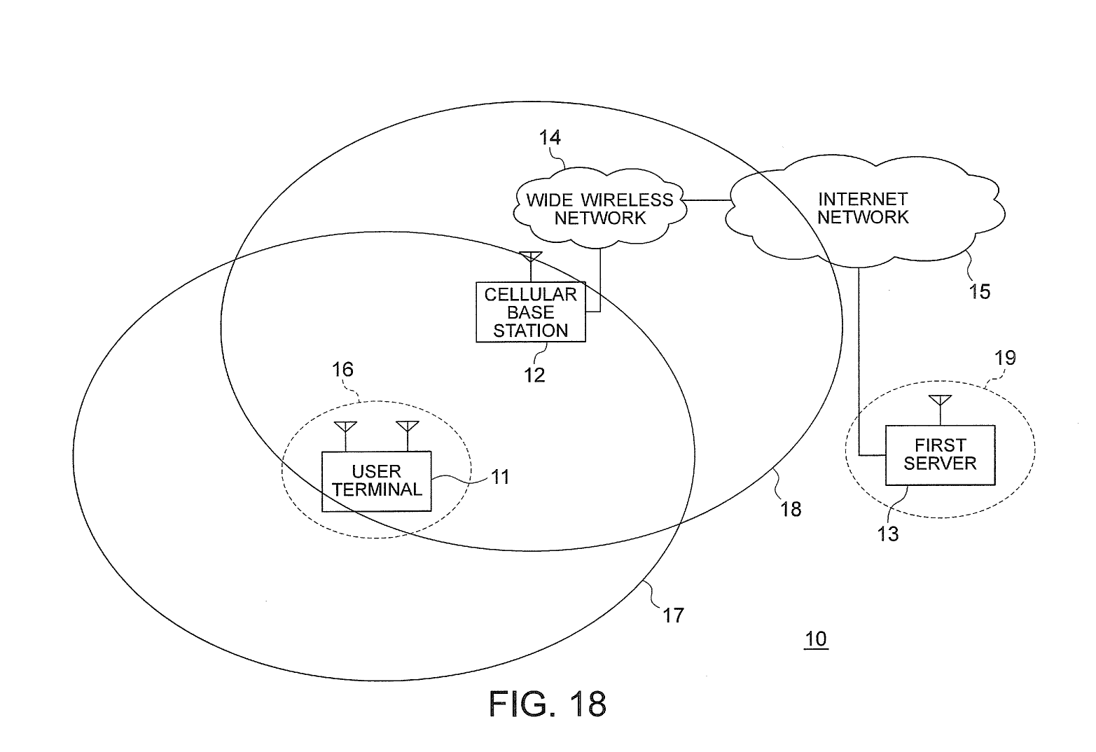

FIG. 18 is a block diagram showing a schematic structure of a wireless communication system 10 having the wireless communication device 1 according to the second embodiment. The wireless communication system 10 of FIG. 18 has a user terminal 11, a cellular base station 12, a first server 13, a wide area wireless communication network 14, and an Internet network 15.

The user terminal 11, which corresponds to the wireless communication device 1 according to the second embodiment, has the first wireless communication unit 2 and the second wireless communication unit 3 as mentioned later.

In FIG. 18, a broken line 16 shows a first communication distance (first communication range) in which the user terminal 11 can perform wireless communication using the first wireless communication unit 2, and a solid line 17 shows a second communication distance (second communication range) in which the user terminal 11 can perform wireless communication using the second wireless communication unit 3.

The cellular base station 12 has a second wireless communication unit (not shown), and can wirelessly communicate with the second wireless communication unit 3 of the user terminal 11 in the second communication distance (wide area). This communication range is shown with a solid line 18. Further, the cellular base station 12 is connected to a wide wireless network 14, and can communicate with the first server 13 through the Internet network 15.

The first server 13 has a first wireless communication unit (not shown), and can wirelessly communicate with the first wireless communication unit 2 of the user terminal 11 in the first communication distance (narrow area). This communication range is shown with a broken line 19.

When entering the communication range 19 of the first server 13, the user terminal 11 transmits its database information to the first server 13 by using the first wireless communication unit 2.

When receiving information about the communication history of the user terminal 11, the first server 13 can acquire, through the Internet network 15, information to be recommended to the user of the user terminal 11 based on the received communication history information. Further, the first server 13 can transmit the acquired recommended information to the user terminal 11 through the first wireless communication unit 2.

The user of the user terminal 11 passes near the first server 13 every day, and downloads his/her desired files while browsing desired websites. Based on the browse history and download history stored in the past, the user can expect the websites and files which will be browsed or downloaded.

When passing near the first server 13, the user terminal 11 transmits, to the first server 13, information about the communication history highly related to the current time. Based on the communication history information, the first server 13 downloads recommend information through the Internet network 15, and transmits it to the user terminal 11.

The user terminal 11 can store, in a local disk in the user terminal 11, desired web sites and desired files received from the first server 13 so that the web sites and files in the local disk can be browsed later. Since the user terminal 11 enables browsing desired web sites and downloading desired files without accessing the cellular base station 12, traffic generated before between the user terminal 11 and the cellular base station 12 can be reduced.

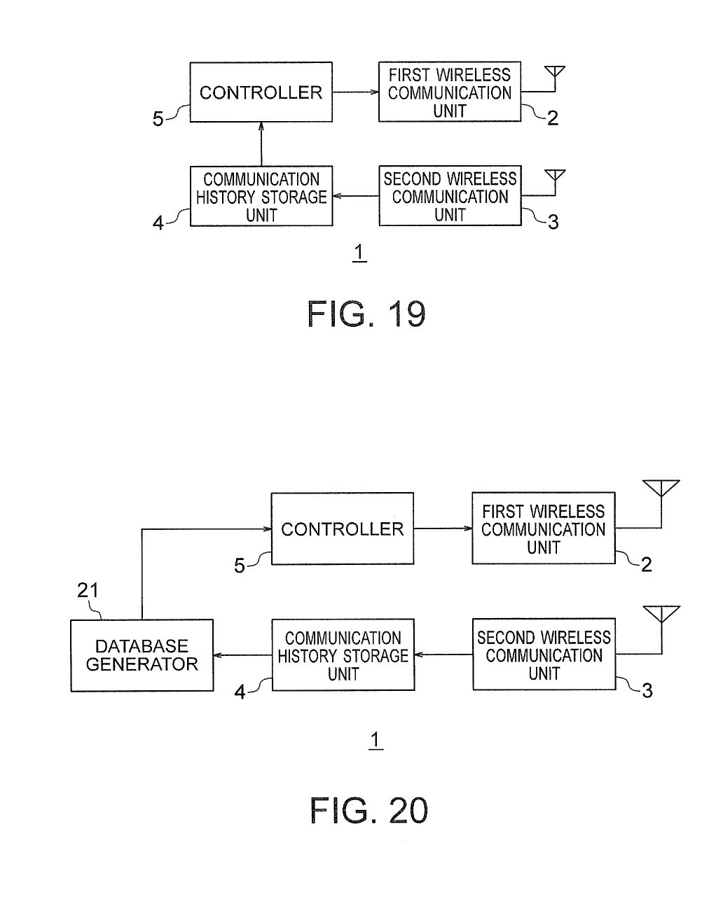

FIG. 19 is a block diagram showing a schematic structure of the wireless communication device 1 (corresponding to the user terminal 11) according to the second embodiment. FIG. 19 is different from FIG. 1 in that information indicating that wireless communication using the first wireless communication unit 2 became available is not transmitted to the communication history storage unit 4. Note that the user terminal 11 may have a configuration similarly to that shown in FIG. 1.

The communication history storage unit 4 of FIG. 19 stores a communication history including access destination information and access time information about the second wireless communication unit 3. Since the communication history stored in the communication history storage unit 4 includes the access destination information and access time information about the second wireless communication unit 3, the controller 5 uses such information to make the first wireless communication unit 2 wirelessly communicate with at least a part of communication partners that the second wireless communication unit 3 wirelessly communicated with in the past.

Therefore, in the present embodiment, communication traffic of the second wireless communication unit 3 in the second communication distance (wide area) can be shared with the first wireless communication unit 2 in the first communication distance (narrow area).

Further, by storing, in the communication history storage unit 4, the communication history including access destination information and access time information about the second wireless communication unit 3, communication traffic of the second wireless communication unit 3 can be estimated with the passage of time. For example, a part of communication to be performed during the hours of communication traffic jam can be previously assigned to the first wireless communication unit 2.

As stated above, in the second embodiment, the user terminal 11 can directly access the first server 13 to perform at least a part of wireless communication previously performed between the user terminal 11 and the cellular base station 12, which makes it possible to reduce communication traffic of the cellular base station 12. Further, large-volume data can be quickly acquired by downloading it directly from the first server 13.

### Third Embodiment

A third embodiment to be explained below is characterized in generating, in the user terminal 11, a database which associates access destination information and access time information of the second wireless communication unit 3 with each other.

FIG. 20 is a block diagram showing a schematic structure of the wireless communication device 1 (user terminal 11) according to the third embodiment. The wireless communication device 1 of FIG. 20 is obtained by adding a database generator 21 to the wireless communication device 1 of FIG. 1. The database generator 21 generates a database which associates access destination information and access time information of the second wireless communication unit 3 with each other.

The first wireless communication unit 2 performs wireless communication in the first communication distance based on the control information inputted from the controller 5. The second wireless communication unit 3 performs wireless communication in the second communication distance based on the control information inputted from an upper layer (not shown), and stores the received data in the communication history storage unit 4.

The data of communication history stored in the communication history storage unit 4 includes access destination information and access time information. Such information is transmitted to the database generator 21.

The database generator 21 generates database including the access destination and access time information transmitted from the communication history storage unit 4, and transmits database information to the controller 5.

Based on the database information transmitted from the database generator 21, the controller 5 outputs, to the first wireless communication unit 2, the data to be transmitted from the first wireless communication unit 2.

Next, the database generator 21 will be explained in detail. The database generator 21 is inputted with data including access destination information and access time, from the communication history storage unit 4. The database to be generated may cover the access destination information and access time information concerning the past single day, or may cover the access destination information and access time information concerning the past few days.

By generating such a database, the controller 5 can quickly judge the timing for making the first wireless communication unit 2 wirelessly communicate with at least a part of access destinations the second wireless communication unit 3 wirelessly communicated with in the past.

Next, the controller 5 will be explained in detail. When the controller 5 receives, from an upper layer (not shown), control information instructing the use of the first wireless communication unit 2 for communication, the controller 5 selects, from the database generated by the database generator 21, an access destination highly related to the current time, and controls the first wireless communication unit 2 to make it transmit data to the access destination. For example, if the current time is 8 o'clock, the highly related access destination is the access destination accessed between 8 o'clock and 9 o'clock yesterday.

As stated above, in the third embodiment, by generating a database which associates access destination with access time when the user terminal 11 performs wireless communication using the second wireless communication unit 3, the controller 5 can efficiently expect the data which will be accessed by the user, based on this database. Therefore, at least a part of wireless communication performed by the second wireless communication unit 3 in the past can be assigned to the first wireless communication unit 2, which makes it possible to reduce the volume of data communicated by the second wireless communication unit 3. Accordingly, communication traffic of the second wireless communication unit 3 can be reduced.

### Fourth Embodiment

A fourth embodiment to be explained below is characterized in that the communication history is stored after being classified as information to be temporarily stored or information to be stored over the long term.

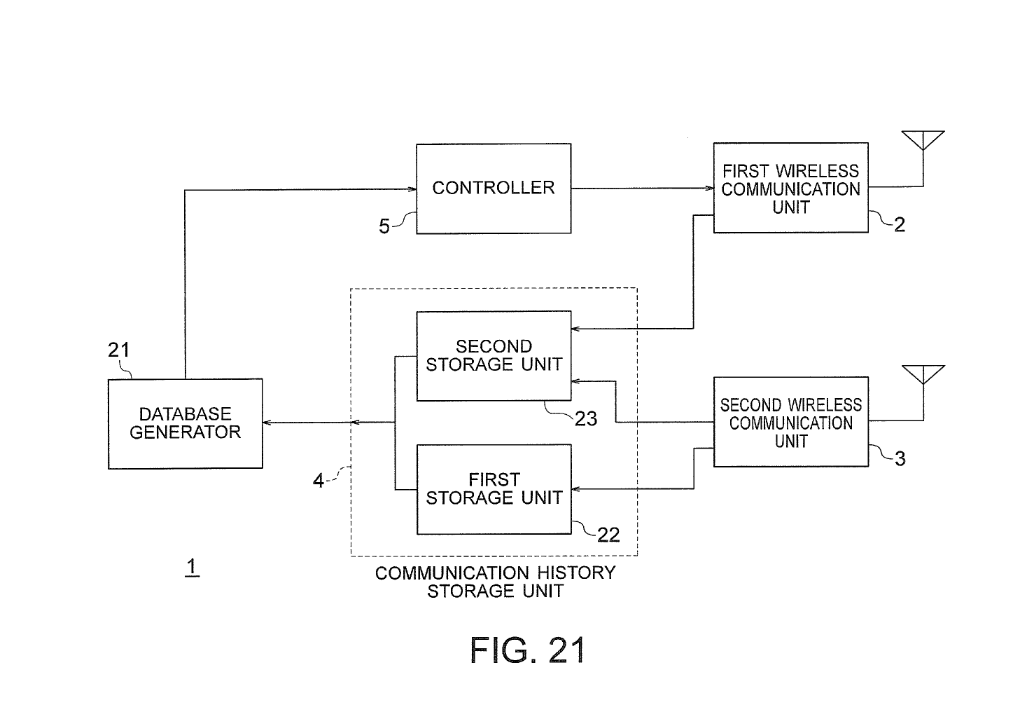

FIG. 21 is a block diagram showing a schematic structure of the wireless communication device 1 (user terminal 11) according to the fourth embodiment. The wireless communication device 1 of FIG. 21 is different from FIG. 20 in the internal structure of the communication history storage unit 4.

The communication history storage unit 4 of FIG. 21 has a first storage unit 22 and a second storage unit 23. In the information acquired by the second wireless communication unit 3 through wireless communication, information to be temporarily stored is stored in the first storage unit 22. Here, the information to be temporary stored is, e.g., information about browsed Web sites. The first storage unit 22 may be a volatile storage device (such as RAM) to erase the information stored therein when the user terminal 11 is turned off. The information to be stored in the first storage unit 22 includes access destination information and access time information, which are transmitted to the database generator 21.

In the information acquired by at least one of the first wireless communication unit 2 and the second wireless communication unit 3 through wireless communication, information to be stored over the long term is stored in the second storage unit 23. Here, the information to be stored over the long term is, e.g., a file downloaded from a Web site. The second storage unit 23 may be a non-volatile storage device (such as flash memory, HDD, SSD, optical disk device, etc.), not to erase the information stored therein when the user terminal 11 is turned off. The information to be stored in the second storage unit 23 includes monitor time information and flag information, in addition to the access destination information and access time information. The monitor time shows the time at which data is outputted responding to an access request from an upper layer (not shown), which is, more concretely, the time at which the user accesses stored information. The flag information is information for identifying whether the stored data is acquired by the first wireless communication unit 2 or the second wireless communication unit 3.

By selectively storing the communication history in the first storage unit 22 or the second storage unit 23, the communication history can be managed more easily, by which the database generator 21 can generate a database more easily. Further, the controller 5 may set a higher priority on an access destination on which the time difference between the access time and monitor time stored in the second storage unit 23 is small so that the access destination is wirelessly accessed by the first wireless communication unit 2. It is assumed that the access destination on which the time difference between the access time and monitor time is small is regarded as more important to the user. When the first wireless communication unit 2 accesses such an access destination preferentially, quick access is possible while reducing communication traffic of the second wireless communication unit 3.

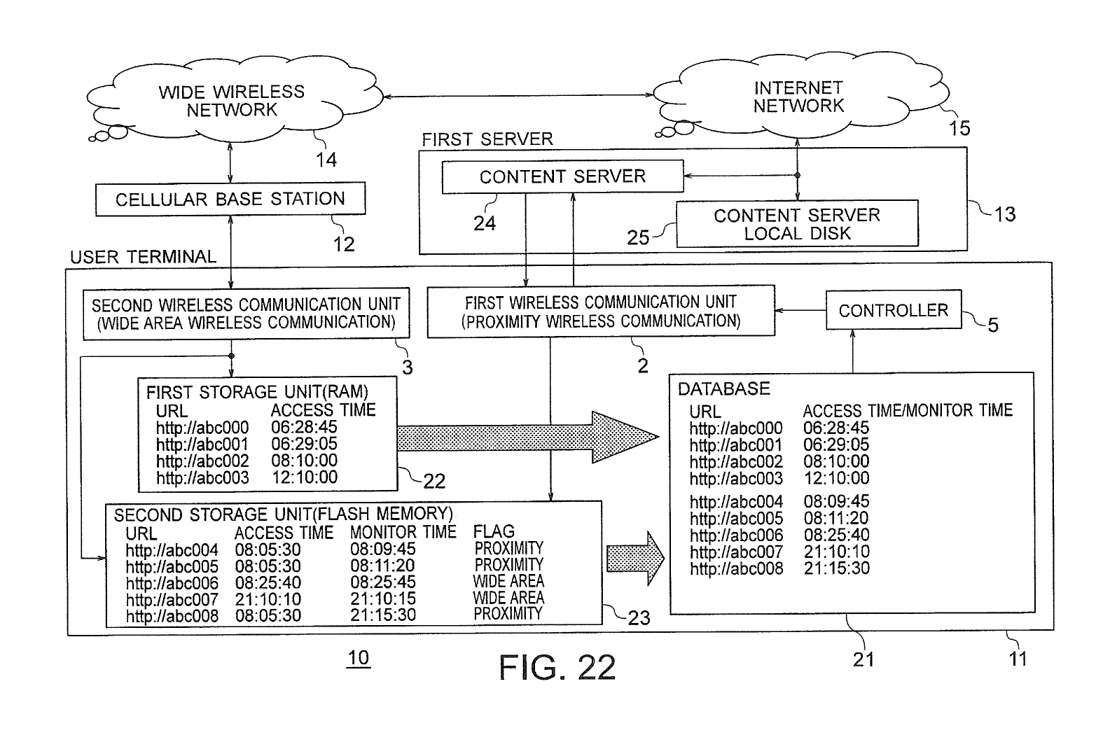

FIG. 22 is a block diagram showing a schematic structure of the wireless communication system 10 having the wireless communication device 1 of FIG. 21. The wireless communication system 10 of FIG. 22 has the user terminal 11 having the same configuration as the wireless communication device 1 of FIG. 21, the cellular base station 12, the wide wireless network 14, the Internet network 15, and the first server 13.

The first server 13 has a content server 24 and a content server local disk 25, for example.

The first storage unit 22 in the user terminal 11, which is e.g. a RAM, stores URL and access information. The second storage unit 23 in the user terminal 11, which is e.g. a flash memory, stores URL, access time, monitor time, and flag information. The database includes URL and access/monitor time.

As stated above, the controller 5 makes the first wireless communication unit 2 preferentially access the URL on which the time difference between the access time and monitor time stored in the second storage unit 23 is small. In this way, the access destination of the first wireless communication unit 2 can be determined by effectively utilizing the communication history stored in the second storage unit 23.

As stated above, in the fourth embodiment, the communication history is stored after being classified as information to be temporarily stored or information to be stored over the long term, by which the communication history can be managed more easily. For example, setting priorities on the access destinations based on the communication history makes it possible to make the first wireless communication unit 2 wirelessly communicate with the access destinations in descending order of priority. In this way, communication traffic of the second wireless communication unit 3 can be reduced.

### Fifth Embodiment

A fifth embodiment is similar to the fourth embodiment except in that the volume of accessed data is further stored in each of the first storage unit 22 and second storage unit 23 in the communication history storage unit 4 of FIG. 21. The database generator 21 generates a database further including the volume of accessed data.

When the controller 5 receives, from an upper layer (not shown), control information instructing the use of the first wireless communication unit 2 for communication, the controller 5 selects, from the database generated by the database generator 21, an access destination highly related to the current time and containing large-volume data, and controls the first wireless communication unit 2 to make it access the access destination.

For example, if the current time is 8 o'clock, the access destination highly related to the current time and containing large-volume data is the access destination having a data volume larger than a predetermined threshold value among the access destinations accessed between 8 o'clock and 9 o'clock yesterday. Instead, if the current time is 8 o'clock, the access destinations between 8 o'clock and 9 o'clock yesterday may be rearranged in descending order of data volume to select an access destination therefrom.

As stated above, in the present embodiment, wireless communication performed within a predetermined time period around the current time and with a communication volume exceeding a predetermined communication volume is preferentially assigned to the first wireless communication unit 2 by the controller 5.

According to the present embodiment, since large-volume data is downloaded preferentially by the first wireless communication unit 2, download time can be shortened while reducing the volume of data communicated with the second wireless communication unit 3. Therefore, data which will be accessed by the user can be expected efficiently, which makes it possible to reduce the volume of data communicated with the second wireless communication unit 3. As a result, traffic of the second wireless communication unit 3 can be reduced.

### Sixth Embodiment

A sixth embodiment, which is a modification example derived from the second embodiment, provides the wireless communication system 10 configured similarly to that of FIG. 18.

The sixth embodiment is different from the second embodiment in the following respect.

The user terminal 11 routinely transmits the database information included in the user terminal 11 to the first server 13 by using the second wireless communication unit 3, through the cellular base station 12, wide wireless network 14, and Internet network 15.

When receiving information about the communication history of the user terminal 11, the first server 13 can acquire, through the Internet network 15, information to be recommended to the user of the user terminal 11 based on the received communication history information. The first server 13 can transmit the acquired recommended information to the user terminal 11 through the first wireless communication unit 2.

Instead of routinely transmits the database information included in the user terminal 11, the user terminal 11 may transmit the database information a certain time earlier than the time when communication volume becomes large based on the database information.

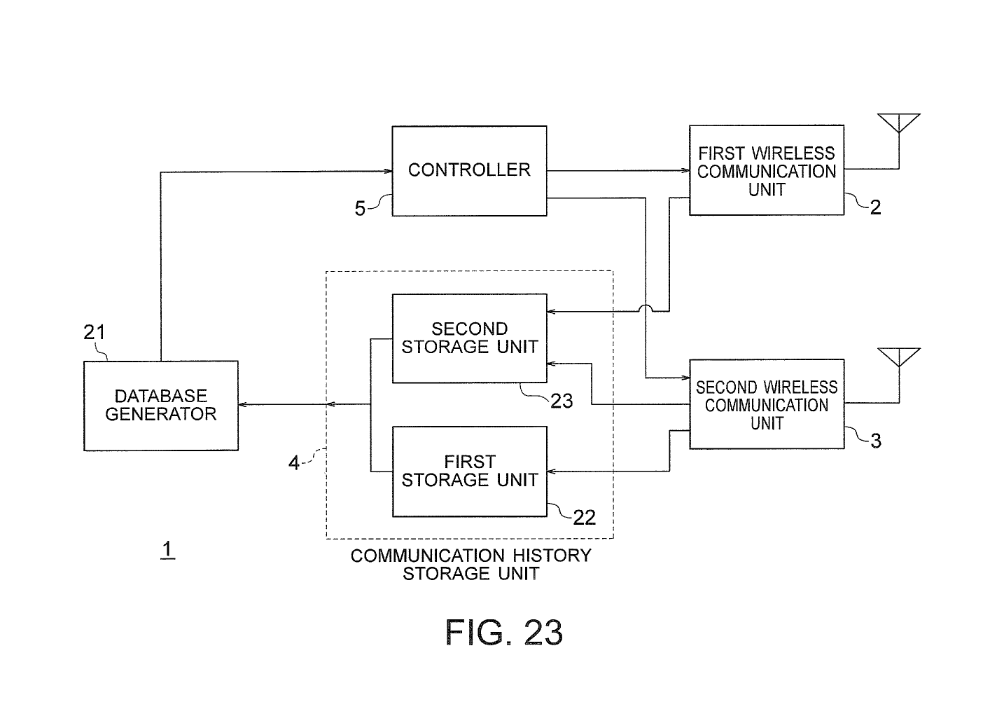

FIG. 23 is a block diagram showing a schematic structure of the wireless communication device 1 (user terminal 11) according to the fifth embodiment. The wireless communication device 1 of FIG. 23 is different from FIG. 21 in that the second wireless communication unit 3 performs wireless communication based on the control information from the controller 5.

More specifically, the second wireless communication unit 3 of FIG. 23 performs wireless communication in the second communication distance, based on the control information from an upper layer (not shown) and a the control information from the controller 5.

The second wireless communication unit 3 stores the data acquired through wireless communication so that data to be temporarily stored is stored in the first storage unit 22, and that data to be stored over the long term is stored in the second storage unit 23.

Based on the database generated by the database generator 21, the controller 5 outputs, to the first wireless communication unit 2, data (individual identification information etc.) to be transmitted from the first wireless communication unit 2, and outputs, to the second wireless communication unit 3, data (database information, individual identification information, etc.) to be transmitted from the second wireless communication unit 3.

According to the sixth embodiment, the database information and individual identification information can be previously transmitted to the first server 13 using the second wireless communication unit 3, and thus the first server 13 can previously acquire, from the Internet network 15, recommended information based on the database information. Therefore, when the user terminal 11 approaches the first server 13 and communicates with it using the first wireless communication unit, the user terminal 11 can receive recommended information from the first server 13 only by transmitting the individual identification information.

In this way, data which will be accessed by the user can be expected efficiently, which makes it possible to reduce the volume of data communicated with the second wireless communication unit 3. As a result, traffic of the second wireless communication unit 3 can be reduced.

### Seventh Embodiment

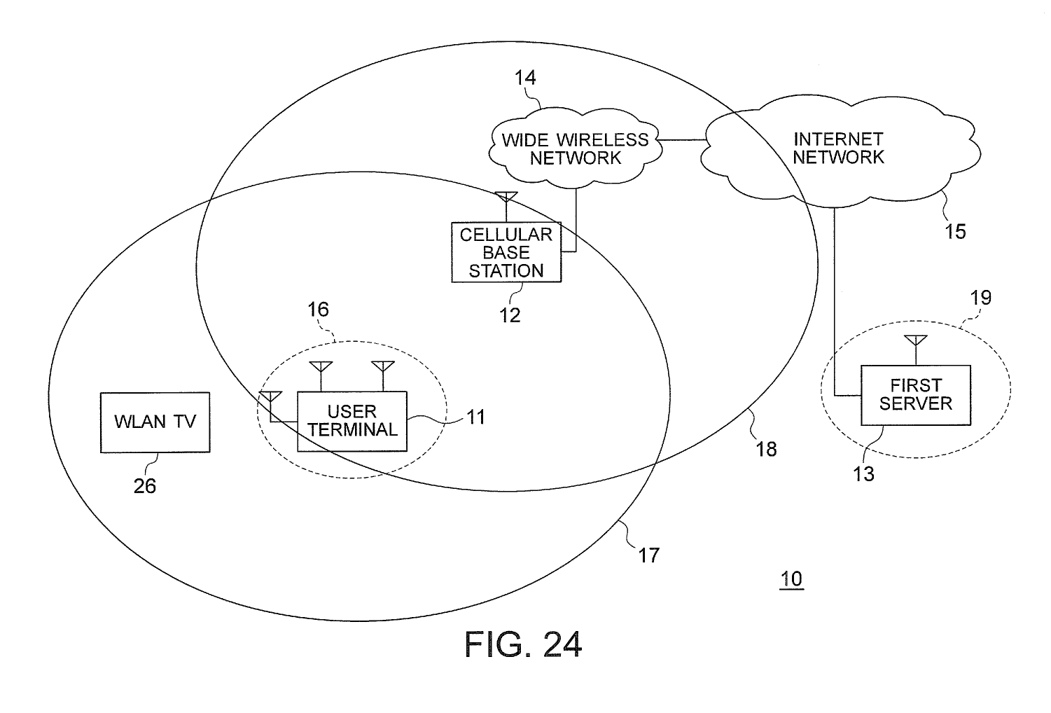

FIG. 24 is a block diagram showing a schematic structure of the wireless communication system 10 according to a seventh embodiment. The wireless communication system 10 of FIG. 24 is obtained by adding a WLAN TV 26 to the wireless communication system 10 of FIG. 21.

The user terminal 11 is the wireless communication device 1 including a third wireless communication unit (not shown) in addition to the first wireless communication unit 2 and the second wireless communication unit 3. The third wireless communication unit is, e.g., communication unit capable of communicating through a wireless LAN.

The user terminal 11 communicates with the WLAN TV 26 using the third wireless communication unit so that the user can view a part of or the whole of data (such as moving image and game) received from the first server 13 or the cellular base station 12 on the WLAN TV 26. For example, Wi-Fi Display is utilized in the communication between the user terminal 11 and the WLAN TV 26.

The user terminal 11 is obtained by adding the third wireless communication unit to the wireless communication device 1 shown in FIG. 23. In this case, each of the monitor time stored in the second storage unit 23 and the monitor time included in the database generated by the database generator 21 shows the time at which the user terminal 11 communicates with the WLAN TV 26 using the third wireless communication unit.

Also in the seventh embodiment, similarly to the second to sixth embodiments, a part of or the whole of wireless communication performed by the second wireless communication unit 3 in the past is assigned to the first wireless communication unit 2 in order to reduce communication traffic of the second wireless communication unit 3. In addition, in the seventh embodiment, data downloaded by the first wireless communication unit 2 or the second wireless communication unit 3 is transmitted to the WLAN TV 26 using the third wireless communication unit so that the user can view the data on the screen of the WLAN TV 26.

In this way, in the seventh embodiment, the user can easily view the data on the large screen of the WLAN TV 26, instead of on the small screen of the user terminal 11.

### Other Modification Examples

The following modification examples can be commonly generated from the first to seventh embodiments.

The first wireless communication unit 2 may support wireless LAN, NFC (Near Field Communication), TransferJET, millimeter-wave communication, etc. In this case, the second wireless communication unit 3 may support cellular communication such as W-CDMA and LTE.

The first wireless communication unit 2 may support NFC, TransferJET, millimeter-wave communication, etc. In this case, the second wireless communication unit 3 may support wireless LAN for example.

The first wireless communication unit 2 may consist of a plurality of wireless communication units. For example, the first wireless communication unit 2 consists of a wireless communication unit communicating at low speed and with low power consumption and a wireless communication unit communicating at high speed and with high power consumption, to use the former wireless communication unit when the volume of data is small and to use the latter wireless communication unit when the volume of data is large. In this case, the wireless communication unit communicating at low speed and with low power consumption may support NFC. Further, the wireless communication unit communicating at high speed and with high power consumption may support TransferJET or millimeter-wave communication.

At least a part of the wireless communication device 1 and wireless communication system 10 explained in the above embodiments may be formed of hardware or software. In the case of software, a program realizing at least a partial function of the wireless communication device 1 and wireless communication system 10 may be stored in a recording medium such as a flexible disc, CD-ROM, etc. to be read and executed by a computer. The recording medium is not limited to a removable medium such as a magnetic disk, optical disk, etc., and may be a fixed-type recording medium such as a hard disk device, memory, etc.

Further, a program realizing at least a partial function of the wireless communication device 1 and wireless communication system 10 can be distributed through a communication line (including radio communication) such as the Internet. Furthermore, this program may be encrypted, modulated, and compressed to be distributed through a wired line or a radio link such as the Internet or through a recording medium storing it therein.

While certain embodiments have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

1. A wireless communication device comprising:
a first wireless communication unit capable of performing wireless communication within a first communication distance;
a second wireless communication unit capable of performing wireless communication within a second communication distance greater than the first communication distance; and
a controller configured to assign at least a part of the wireless communication performed by the second wireless communication unit to the first wireless communication unit instead of the second wireless communication unit, based on a communication history of the second wireless communication unit stored after the wireless communication using the first wireless communication unit becomes available.

2. A wireless communication device comprising:
a first wireless communication unit capable of performing wireless communication within a first communication distance;
a second wireless communication unit capable of performing wireless communication within a second communication distance greater than the first communication distance; and
a database generator configured to generate a database which associates access destination information and access time information of the second wireless communication unit, based on a communication history including the access destination information and the access time information; and
a controller configured to assign at least a part of the wireless communication performed by the second wireless communication unit to the first wireless communication unit instead of the second wireless communication unit, based on the database.

3. The wireless communication device of claim 1,
wherein the communication history includes information expressing an access destination as a list form.

4. The wireless communication device of claim 1,
wherein the communication history includes information expressing frequency of access for each access destination as a list form.

5. The wireless communication device of claim 1,
wherein the communication history includes information expressing time of access for each access destination as a list form.

6. The wireless communication device of claim 1,
wherein the communication history includes information associated with a communication partner of the first wireless communication unit after the communication partner becomes available for the wireless communication.

7. The wireless communication device of claim 1, further comprising:
a communication history storage unit configured to store the communication history.

8. The wireless communication device of claim 2, further comprising:
a communication history storage unit configured to store the communication history,
wherein the communication history storage unit comprises:
a first storage unit configured to store information concerning the access destination information and access time information of the second wireless communication unit; and
a second storage unit configured to store information stored for a longer period than the information stored in the first storage unit, the information stored in the second storage unit including information concerning the access destination information and access time information of at least one of the second wireless communication unit and, the first wireless communication unit, information indicating which one of the first wireless communication unit and the second wireless communication unit is used to perform communication, and monitor time information indicating time at which the stored information is accessed, and
the database generator generates the database based on the information stored in the first and second storage units.

9. The wireless communication device of claim 8,
wherein the controller sets priorities on the access destination information stored in the second storage unit based on a difference between the access time information and monitor time information stored in the second storage unit, and allows the first wireless communication unit to perform wireless communication with the access destinations in descending order of priority.

10. The wireless communication device of claim 8,
wherein the first storage unit and the second storage unit further store communication volume of the wireless communication performed by the first wireless communication unit and the second wireless communication unit respectively, and
the controller preferentially allows the first wireless communication unit to perform wireless communication which is performed within a predetermined time period after the current time and has a communication volume exceeding a predetermined communication volume.

11. The wireless communication device of claim 8,
wherein the first storage unit is a volatile storage device,
the second storage unit is a non-volatile storage device, and
the second storage unit stores information concerning the access destination information and access time information when downloading at least one file from a communication destination.

12. The wireless communication device of claim 2,
wherein the controller performs control for routinely transmitting the database generated by the database generator to a communication partner through the second wireless communication unit.

13. The wireless communication device of claim 7,
wherein the communication history storage unit stops storing the communication history of the second wireless communication unit after a predetermined time has elapsed since the wireless communication by the first wireless communication unit became available.

14. The wireless communication device of claim 7,
wherein the communication history storage unit stops storing the communication history of the second wireless communication unit when a predetermined instruction is given after the wireless communication by the first wireless communication unit becomes available.

15. A wireless communication device comprising:
a first wireless communication unit capable of performing wireless communication within a first communication distance;
a second wireless communication unit capable of performing wireless communication within a second communication distance greater than the first communication distance; and
a communication history storage unit configured to store a communication history of the second wireless communication unit; and
a controller configured to allow the first wireless communication unit to perform the wireless communication, based on the communication history.

16. The wireless communication device of claim 15,
wherein the communication history includes information expressing an access destination as a list form.

17. The wireless communication device of claim 15,
wherein the communication history includes information expressing frequency of access for each access destination as a list form.

18. The wireless communication device of claim 15,
wherein the communication history includes information expressing time of access for each access destination as a list form.

19. The wireless communication device of claim 15,
wherein the communication history includes information associated with a communication partner of the first wireless communication unit after the communication partner becomes available for the wireless communication.

20. The wireless communication device of claim 15, wherein the communication history storage unit comprises:
a first storage unit configured to store information concerning the access destination information and access time information of the second wireless communication unit; and
a second storage unit configured to store information stored for a longer period than the information stored in the first storage unit, the information stored in the second storage unit including information concerning the access destination information and access time information of at least one of the second wireless communication unit and the first wireless communication unit, information indicating which one of the first wireless communication unit and the second wireless communication unit is used to perform communication, and monitor time information indicating time at which the stored information is accessed, and
the controller allows the first wireless communication unit to perform wireless communication based on the information stored in the first and second storage units.
